(19) United States
(12) Patent Application Publication
(10) Pub. No.: US 2018/0257431 A1
(43) Pub. Date: Sep. 13, 2018

(54) CONNECTIVE UNIT TO CONNECT A ROLLER WITH A SEAT'S LEG

(71) Applicant: Wen-Chin Cheng, New Taipei City (TW)

(72) Inventor: Wen-Chin Cheng, New Taipei City (TW)

(21) Appl. No.: 15/694,676

(22) Filed: Sep. 1, 2017

(30) Foreign Application Priority Data
Mar. 13, 2017 (TW) 106203463

(51) Int. Cl. B60B 33/00; F16C 11/04

(52) U.S. Cl. CPC B60B 33/0026; F16C 11/04; B60B 33/0021; A47C 7/006; B60B 33/0044; B60B 33/0049; B60B 33/0068; B60B 33/001

(57) ABSTRACT

A connective unit to connect a roller with a seat's leg is disclosed. The connective unit comprises a supportive arm, a plastic cylindrical member, a pivotally connective member and a roller. The plastic cylindrical member may engage with a cylindrical hole provided in the supportive arm. The upper end of the pivotally connective member may engage with a first connective hole and the lower end of the pivotally connective member may engage with a second connective hole of the roller. Thanks to presence of the plastic cylindrical member, when the pivotally connective member rotates and causes the roller to rotate with it, the supportive arm doesn't have any contact with the pivotally connective member and thus noisy friction and impacts between them as in the prior art may be avoided. Therefore, the plastic cylindrical member is difficult to wear out as the pivotally connective member rotates.

### BACKGROUND OF THE INVENTION

### 1. Field of the Invention

The invention generally relates to a connective unit to connect a roller with a seat's leg. More particularly, the invention relates to a connective unit in which the wear and tear between the supportive arm and the pivotally connective member may be avoided over a long period of time.

### 2. Description of the Prior Art

In the prior art, a seat has several legs, each of which has a supportive arm. A hole is provided in the lower portion of each supportive arm and a pivotally connective member may engage with the hole so to link up the supportive arm with a roller and hence to allow the seat to rotate and move around. Because the supportive arms need to support a user's weight, the supportive arms are usually made of a metallic material so that they would not be bent by the user's weight. The pivotally connective members also need to support the weight; they are usually made of a metallic material too.

Because the supportive arms and pivotally connective members are metallic, the holes would be worn out over a certain period of use and undesirable noises may be generated due to the loose engagement between the pivotally connective members and the holes. Such loose engagement may cause a roller to fall off.

From the above, we can see that the prior art design has many disadvantages and needs to be improved. To eliminate the disadvantages, the inventor has put in a lot of effort in the subject and has successfully come up with the connective unit (to connect a roller with a seat's leg) of the present invention.

### SUMMARY OF THE INVENTION

To overcome the aforesaid disadvantages, the object of the present invention is to provide a connective unit in which the wear and tear between the supportive arm and the pivotally connective member may be avoided.

The connective unit comprises a supportive arm, a plastic cylindrical member, a pivotally connective member and a roller. The plastic cylindrical member may tightly engage with the cylindrical hole because the former's shape matches with the latter's shape. The upper portion of the pivotally connective member may engage with a first connective hole and the lower portion of the pivotally connective member may engage with a second connective hole of the roller.

A circular notch is provided in the upper portion of the pivotally connective member and a circular elastic member is disposed onto the circular notch. When the circular elastic member is disposed onto the circular notch, the former's outer diameter is greater than that of the pivotally connective member.

A gap exists between the circular elastic member and the longitudinal width of the circular notch. Alternatively, the circular elastic member may be tightly held onto the circular notch.

### BRIEF DESCRIPTION OF THE DRAWINGS

FIG. 1 is a perspective view of the connective unit (to connect a roller with a seat's leg) of the present invention.

FIG. 2 is an exploded view of the connective unit of the present invention.

FIG. 3 is a partially enlarged sectional view illustrating how the pivotally connective member engages with the plastic cylindrical member.

FIG. 4 is a sectional view illustrating how the pivotally connective member engages with the plastic cylindrical member in an alternative design.

### DETAILED DESCRIPTION OF THE PREFERRED EMBODIMENT

Although a preferred embodiment of the present invention will be described in detail in the following, it should be understood that the preferred embodiment should be regarded in an illustrative manner rather than a restrictive manner.

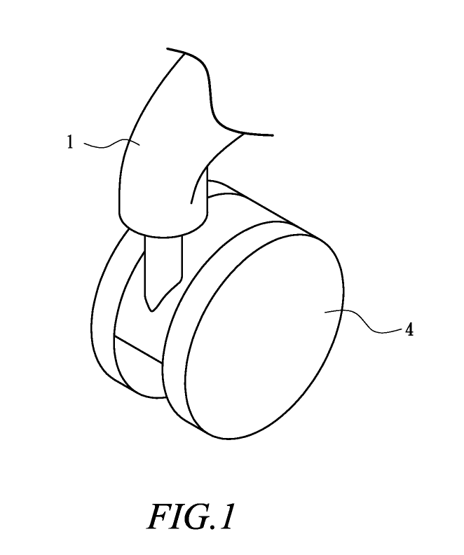

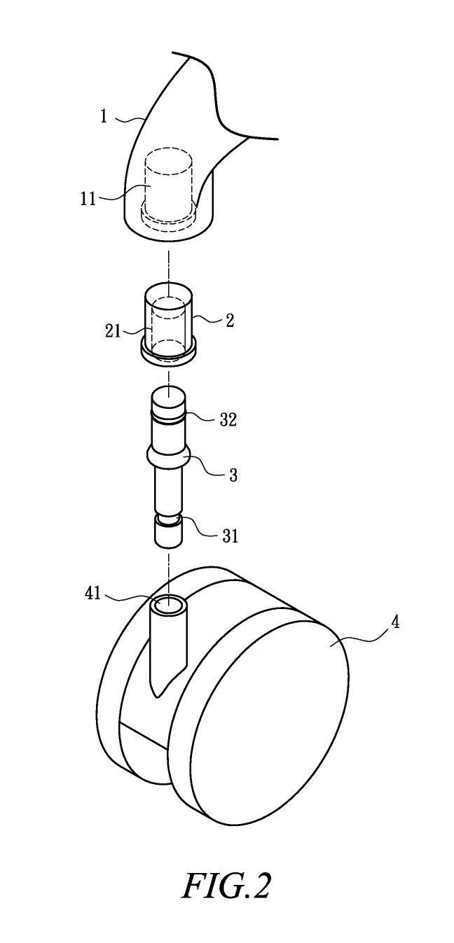

First, please refer to FIGS. 1 to 3. The connective unit comprises a supportive arm 1, a plastic cylindrical member 2, a pivotally connective member 3 and a roller 4. The supportive arm 1 radially extends outwardly from a seat's leg. The plastic cylindrical member 2 may engage with a corresponding supportive arm 1. A cylindrical hole 11 is provided at the lower portion of the supportive arm 1 and may be a blind hole or have a step-like structure. A connective hole 21 is provided at the lower portion of the plastic cylindrical member 2. The plastic cylindrical member 2 may tightly engage with the cylindrical hole 11 because the former's shape matches with the latter's shape. The upper portion of the pivotally connective member 3 may pivotally engage with the first connective hole 21 and the lower portion of the pivotally connective member 3 may pivotally engage with a connective hole 41 provided in the upper portion of the roller 4.

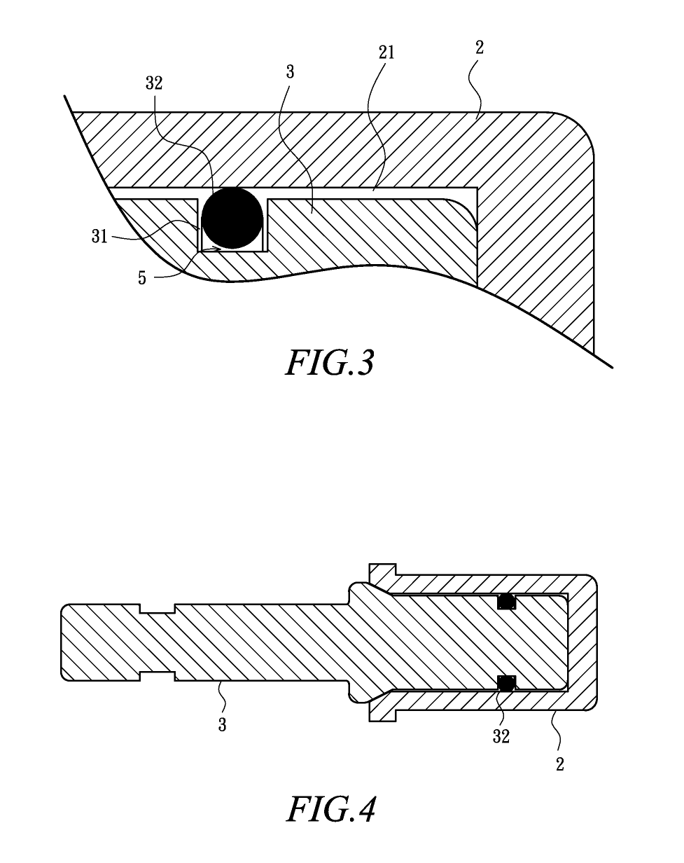

A circular notch 31 is provided in the upper portion of the pivotally connective member 3 and a circular elastic member 32 is disposed onto the circular notch 31. When the circular elastic member 32 is disposed onto the circular notch 31, the former's outer diameter is greater than that of the pivotally connective member 3. A gap 5 exists between the circular elastic member 32 and the longitudinal width of the circular notch 31. After the upper end of the pivotally connective member 3 engages with the connective hole 21, the gap 5 would allow the pivotally connective member 3 to rotate within the connective hole 21 and with respect to the circular elastic member 32; therefore, this rotation would directly cause the roller 4 to rotate or indirectly cause the roller 4 to rotate via the second connective hole 41. Alternatively, as shown by FIG. 4, the circular elastic member 32 may be tightly held onto the circular notch 31 due to the pressure exerted by the inner wall of the connective hole 21, rendering the former unable to rotate with respect to the latter; therefore, the roller 4 may be rotated only by the relative rotation between the pivotally connective member 3 and the connective hole 41.

In comparison to the prior art, the connective unit of the present invention has the following two characteristics or advantages:

1. Thanks to presence of the plastic cylindrical member, when the pivotally connective member rotates and causes the roller to rotate with it, the supportive arm doesn't have any contact with the pivotally connective member and thus noisy friction and impacts between them as in the prior art may be avoided.
2. Because the plastic cylindrical member is made of a plastic material, it is difficult to wear out as the pivotally connective member rotates; therefore, service life of a seat's legs and rollers may be prolonged.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

What is claimed is:

1. A connective unit (to connect a roller with a seat's leg), comprising:
a seat's leg, which has an outwardly extending supportive arm, wherein a cylindrical hole is provided in the lower portion of the supportive arm;
a plastic cylindrical member, which may engage with the cylindrical hole;
a pivotally connective member, whose upper end may engage with the plastic cylindrical member; and
a roller, wherein the lower portion of the pivotally connective member may pivotally engage with a connective hole provided in the upper portion of the roller.

2. The connective unit as in claim 1, wherein a circular notch is provided in the upper portion of the pivotally connective member and a circular elastic member is disposed onto the circular notch, characterized in that when the circular elastic member is disposed onto the circular notch, the former's outer diameter is greater than that of the pivotally connective member, and that a gap exists between the circular elastic member and the longitudinal width of the circular notch.

3. The connective unit as in claim 1, wherein a circular notch is provided in the upper portion of the pivotally connective member and a circular elastic member is disposed onto the circular notch, characterized in that when the circular elastic member is disposed onto the circular notch, the former's outer diameter is greater than that of the pivotally connective member, and that the circular elastic member may be tightly held onto the circular notch.
